(19) United States
(12) Patent Application Publication
(10) Pub. No.: US 2023/0176562 A1
(43) Pub. Date: Jun. 8, 2023

(54) PROVIDING AN ALARM RELATING TO ANOMALY SCORES ASSIGNED TO INPUT DATA METHOD AND SYSTEM

(71) Applicant: SIEMENS AKTIENGESELLSCHAFT, München (DE)

(72) Inventors: Roman Eichler, Nürnberg (DE); Vladimir Lavrik, Dreieich (DE)

(21) Appl. No.: 18/013,894

(22) PCT Filed: Jun. 30, 2021
(86) PCT No.: PCT/EP2021/067970

§ 371 Date: Dec. 29, 2022

(30) Foreign Application Priority Data
Jun. 30, 2020 (EP) 20183021.3

(51) Int. Cl. G05B 23/02

(52) U.S. Cl. CPC G05B 23/027; G05B 23/0283; G05B 2223/04

(57) ABSTRACT

For improved provision of an alarm relating to anomaly scores assigned to input data, a method includes receiving input data relating to at least one device. The input data includes incoming data batches X relating to at least N separable classes. Respective anomaly scores are determined for the respective incoming data batch X relating to the at least N separable classes using N anomaly detection models. The anomaly detection models are applied to the input data to generate output data. A difference is determined, for the respective incoming data batch X, between the determined respective anomaly scores for the at least N separable classes and given respective anomaly scores of the N anomaly detection models. When the respective determined difference is greater than a difference threshold, an alarm relating to the determined difference is provided to a user, the respective device, and/or an IT system connected to the respective device.

This application is the National Stage of International Application No. PCT/EP2021/067970, filed Jun. 30, 2021, which claims the benefit of European Patent Application No. EP 20183021.3, filed Jun. 30, 2020. The entire contents of these documents are hereby incorporated herein by reference.

### TECHNICAL FIELD

The present disclosure is directed, in general, to software management systems, and, more specifically, to systems for providing an alarm relating to anomaly scores assigned to input data.

### BACKGROUND

Recently, an increasing number of computer software products involving artificial intelligence, machine learning, etc. is used for performing various tasks. Such computer software products may, for example, serve for purposes of voice, image, or pattern recognition. Further, such computer software products may directly or indirectly (e.g., by embedding them in more complex computer software products) serve to analyze, monitor, operate, and/or control a device (e.g., in an industrial environment).

Currently, there exist product systems and solutions that support analyzing, monitoring, operating, and/or controlling a device using anomaly detection models and that support management of such computer software products involving anomaly scores. Such product systems may benefit from improvements.

### SUMMARY AND DESCRIPTION

The scope of the present invention is defined solely by the appended claims and is not affected to any degree by the statements within this summary.

Variously disclosed embodiments include methods and computer systems that may be used to facilitate providing an alarm relating to anomaly scores assigned to input data and managing computer software products.

According to a first aspect of the present embodiments, a computer-implemented method may include: receiving input data relating to at least one device, where the input data includes incoming data batches X relating to at least N separable classes, with nϵ1, . . . , N; determining respective anomaly scores s1, . . . , sn for the respective incoming data batch X relating to the at least N separable classes using N anomaly detection models Mn; applying the (trained) anomaly detection models Mn to the input data to generate output data, the output data being suitable for analyzing, monitoring, operating, and/or controlling the respective device; determining, for the respective incoming data batch X, a difference between the determined respective anomaly scores s1, . . . , sn for the at least N separable classes and given respective anomaly scores S1, . . . , Sn of the N anomaly detection models Mn (130); if the respective determined difference between is greater than a difference threshold, providing an alarm relating to the determined difference to a user, the respective device, and/or an IT system connected to the respective device.

By way of example, the input data may be received with a first interface. Further, the respective anomaly detection model may be applied to the input data with a computation unit. In some examples, the alarm relating to anomaly scores assigned to the input data may be provided with a second interface.

According to a second aspect of the present embodiments, a system, such as for example, a computer system or IT system, may be arranged and configured to execute the acts of this computer-implemented method. For example, the system may include: a first interface, configured for receiving input data relating to at least one device, where the input data includes incoming data batches X relating to at least N separable classes, with nϵ1, . . . , N. The system also includes a computation unit configured for: determining respective anomaly scores s1, . . . , sn for the respective incoming data batch X relating to the at least N separable classes using N anomaly detection models Mn; applying the anomaly detection models Mn to the input data to generate output data, the output data being suitable for analyzing, monitoring, operating, and/or controlling the respective device; determining, for the respective incoming data batch X, a difference between the determined respective anomaly scores s1, . . . , sn for the at least N separable classes and given respective anomaly scores S1, . . . , Sn of the N anomaly detection models Mn 130. The system also includes a second interface configured for providing an alarm relating to the determined difference to a user, the respective device, and/or an IT system connected to the respective device, if the respective determined difference between is greater than a difference threshold.

According to a third aspect of the present embodiments, a computer program may include instructions that, when the program is executed by a system (e.g., an IT system), cause the system to carry out the described method of providing an alarm relating to anomaly scores assigned to input data.

According to a fourth aspect of the present embodiments, a computer-readable medium may include instructions that, when executed by a system (e.g., an IT system), cause the system to carry out the described method of providing an alarm relating to anomaly scores assigned to input data. By way of example, the described computer-readable medium may be non-transitory and may further be a software component on a storage device.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the detailed description below, various definitions for certain words and phrases are provided throughout this patent document and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates providing an alarm in a product system.

FIG. 2 illustrates a degradation of a trained model in time due to a data distribution shift.

FIG. 3 illustrates an exemplary data distribution drift detection for a binary classification task.

FIG. 4 illustrates an exemplary boxplot which compares two distributions of anomaly scores.

FIG. 5 illustrates a functional block diagram of an example system that facilitates providing an alarm and managing computer software products in a product system.

FIG. 6 illustrates another flow diagram of an example methodology that facilitates providing an alarm in a product system.

FIG. 7 illustrates an embodiment of an artificial neural network.

FIG. 8 illustrates an embodiment of a convolutional neural network.

FIG. 9 illustrates a block diagram of a data processing system in which an embodiment may be implemented.

### DETAILED DESCRIPTION

Various technologies that pertain to systems and methods for providing an alarm and for managing computer software products in a product system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for example, an element may be configured to perform functionality that is described as being carried out by multiple elements. The numerous innovative teachings of the present patent document will be described with reference to exemplary non-limiting embodiments.

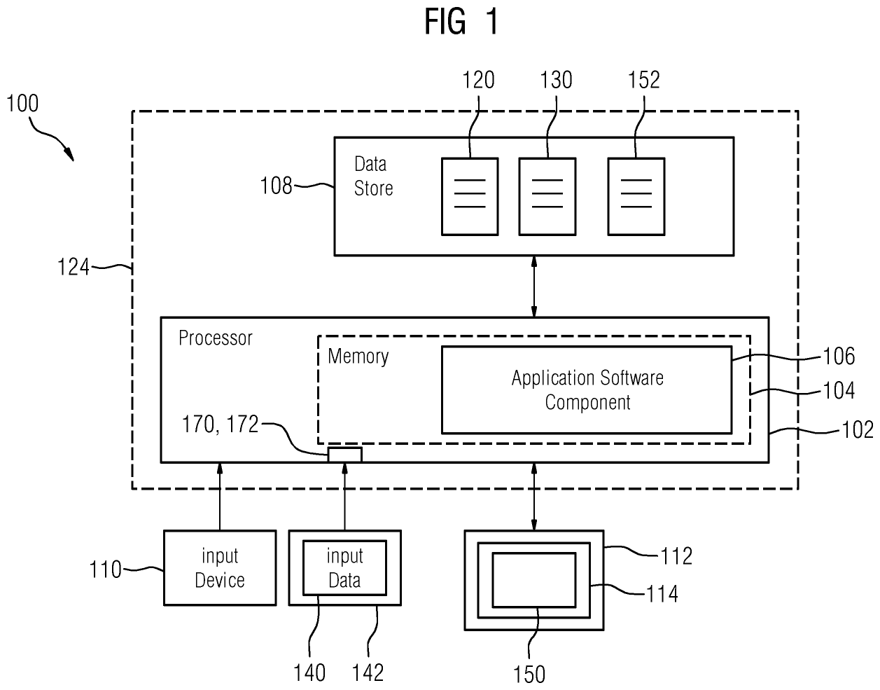

With reference to FIG. 1, an example computer system or data processing system 100 that facilitates providing an alarm 150 (e.g., providing an alarm 150 relating to anomaly scores assigned to input data 140, such as detecting a distribution drift of the incoming data 140 using anomaly detection models 130) is illustrated. The processing system 100 may include at least one processor 102 that is configured to execute at least one application software component 106 from a memory 104 accessed by the processor 102. The application software component 106 may be configured (e.g., programmed) to cause the processor 102 to carry out various acts and functions described herein. For example, the described application software component 106 may include and/or correspond to one or more components of an application that is configured to provide and store output data in a data store 108 such as a database.

It may be difficult and time-consuming to provide an alarm 150 in complex application and industrial environments. For example, advanced coding knowledge of users or IT experts may be required, or selections of many options need to be made consciously, both involving many manual steps, which is a long and not efficient process.

To enable the enhanced provision of an alarm 150, the described product system or processing system 100 may include at least one input device 110 and optionally at least one display device 112 (e.g., a display screen). The described processor 102 may be configured to generate a GUI 114 through the display device 112. Such a GUI 114 may include GUI elements such as buttons, text boxes, images, scroll bars usable by a user to provide inputs through the input device 110 that may support providing the alarm 150.

In an example embodiment, the application software component 106 and/or the processor 102 may be configured to receive input data 140 relating to at least one device 142, where the input data 140 includes incoming data batches X relating to at least N separable classes, with nϵ1, . . . , N. Further, the application software component 106 and/or the processor 102 may be configured to determine respective anomaly scores s1, . . . , sn for the respective incoming data batch X relating to the at least N separable classes using N anomaly detection models Mn 130. In some examples, the application software component 106 and/or the processor 102 may further be configured to apply the anomaly detection models Mn 130 to the input data 140 to generate output data 152. The output data 152 is suitable for analyzing, monitoring, operating, and/or controlling the respective device 142. The application software component 106 and/or the processor 102 may further be configured to determine, for the respective incoming data batch X, a difference between the determined respective anomaly scores s1, . . . , sn for the at least N separable classes and given respective anomaly scores S1, . . . , Sn of the N anomaly detection models Mn 130. Further, the application software component 106 and/or the processor 102 may be configured to provide an alarm 150 relating to the determined difference to a user (e.g., via the GUI 114), the respective device 142, and/or an IT system connected to the respective device 142, if the respective determined difference is greater than a difference threshold.

In some examples, the respective anomaly detection model Mn 130 is provided beforehand and stored in the data store 108.

The input device 110 and the display device 112 of the processing system 100 may be considered optional. In other words, the sub-system or computation unit 124 included in the processing system 100 may correspond to the claimed system (e.g., IT system), which may include one or more suitably configured processors and memory.

By way of example, the input data 140 may include incoming data batches X relating to at least N separable classes, with nϵ1, . . . , N. The data batches may, for example, include measured sensor data (e.g., relating to a temperature, a pressure, an electric current and electric voltage, a distance, a speed or velocity, an acceleration, a flow rate, electromagnetic radiation including visible light, or any other physical quantity). In some examples, the measured sensor data may also relate to chemical quantities, such as acidity, a concentration of forgiven substance in the mixture of substances, and so on. The respective variable may, for example, characterize the respective device 142 or the status in which the respective device 142 is. In some examples, the respective measured sensor data may characterize a machining or production step that is carried out or monitored by the respective device 142.

The respective device 142 may, in some examples, be or include a sensor, an actuator, such as an electric motor, a valve, or a robot, and inverter supplying an electric motor, a gear box, a programmable logic controller (PLC), a communication gateway, and/or other parts component relating to industrial automation products and industrial automation in general. The respective device 142 may be part of a complex production line or production plant (e.g., a bottle filing machine, conveyor, welding machine, welding robot, etc.). In further examples, there may be input data messages 142 relating to one or more variables of a plurality of such devices 142. Further, by way of example, the IT system may be or include a manufacturing operation management (MOM) system, a manufacturing execution system (MES), and enterprise resource planning (ERP) system, a supervisory control and data acquisition (SCADA) system, or any combination thereof.

The input data 140 may be used to generate output data 152 by applying anomaly detection models Mn 130 to the input data 140. The anomaly detection models Mn 130 may, for example, correlate the input data messages or the respective variable to the output data 152. The output data 152 may be used to analyze or monitor the respective device 142 (e.g., to indicate whether the respective device 142 is working properly or the respective device 142 is monitoring a production step that is working properly). In some examples, the output data 152 may indicate that the respective device 142 is damaged or that there may be problems with the production step that is monitored by the respective device 142. In other examples, the output data 152 may be used to operate or control the respective device 142 (e.g., implementing a feedback loop or a control loop using the input data 140, analyzing the input data messages 140 by applying the anomaly detection models Mn 130, and controlling or operating the respective device 142 based on the received input data 140). In some examples, the device 142 may be a valve in a process automation plant, where the input data messages include data on a flow rate as a physical variable. The flow rate is then analyzed with the anomaly detection models Mn 130 to generate the output data 152, where the output data 152 includes one or more target parameters for the operation of the valve (e.g., a target flow rate or target position of the valve).

The incoming data batches X of the input data 140 may relate to at least N separable classes. In a rather simple example, there may be two classes: class 1 indicating that the device 142 or a corresponding production plant is in an “okay” state; and class 2 indicating that the device 142 or a corresponding production plant is in a “not okay” state. For example, the device 142 may correspond to a bearing of a gearbox or to a belt conveyor, where class 1 may indicate proper operation of the device 142 and class 2 may indicate that the bearing does not have sufficient lubricant or that the belt of the belt conveyor is to lose. Generally, the different N classes may relate to typical scenarios of the monitored device that in some examples may be a physical object. Hence, the N classes may correspond to a state of proper operation and to N−1 typical failure modes of the physical device 142. In some examples, domain model may separate an “okay” state from a “not okay” state, where there may be sub-ordinate classes that specify in more detail what kind of “not okay” state the device 142 is in.

In some examples, the anomaly detection models Mn 130 may be trained anomaly detection models Mn. The training of such trained anomaly detection models Mn may, for example, be done using a reference data set or a training data set. A reference data set may be provided beforehand, for example, by identifying typical scenarios and the scenarios related to typical variables or input data 140. Such typical scenarios may, for example, be a scenario when the respective device 142 is working properly, when the respective device 142 monitors a properly executed production step, when the respective device 142 is damaged, when the respective device 142 monitors an improperly executed production step, and so on. By way of example, the device 142 may be a bearing that is getting too hot during its operation and hence has increased friction. Such scenarios may be analyzed or recorded beforehand so that corresponding reference data may be provided. When corresponding input data 140 is received, this input data 140 may be compared with the reference data set to determine the respective anomaly scores sn for the respective incoming data batch X relating to the at least N separable classes using N anomaly detection models Mn 130.

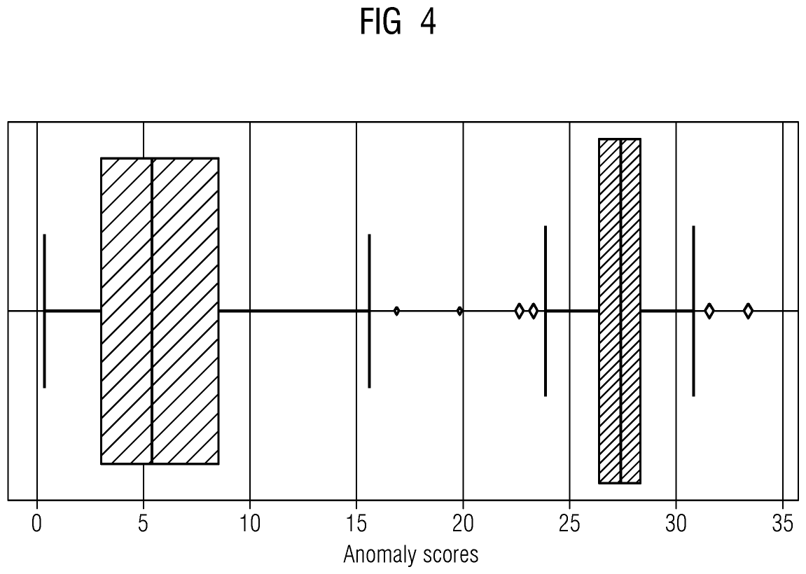

For every new and previously unseen batch X of input data, descriptive statistics of anomaly scores sn may be determined and compared with corresponding descriptive statistics Sn obtained for every model Mn. Hereby, the descriptive statistics for the respective anomaly scores sn or Sn may include corresponding median values, standard deviations, and/or interquartile ranges of the respective anomaly scores sn or Sn. Herein, in descriptive statistics, the interquartile range (IQR), also referred to as the midspread, middle 50%, or H-spread, is a measure of a statistical dispersion, being equal to the difference between 75th and 25th percentiles, or between upper and lower quartiles, so that IQR=Q3−Q1. In other words, the IQR is the first quartile subtracted from the third quartile; these quartiles may be clearly seen on a box plot on the data, of which an example is illustrated in FIG. 4. The IQR may be a trimmed estimator, defined as the 25% trimmed range, and is a commonly used robust measure of scale.

The IQR may be considered as a measure of variability, based on dividing a data set into quartiles. Quartiles divide a rank-ordered data set into four equal parts. The values that separate parts are referred to as the first, second, and third quartiles, which are denoted by Q1, Q2, and Q3, respectively.

If the comparison of the anomaly scores sn with the anomaly scores S1, . . . , Sn of the N anomaly detection models Mn 130 (or of the corresponding descriptive statistics on sn and Sn) reveals significant differences that may be the case if the determined difference is greater than the difference threshold, a data distribution drift may detected and a warning may be sent to the user, the respective device 142, and/or the IT system that may indicate that a data drift has occurred and/or the anomaly detection models may not be trustworthy anymore.

In some examples, the given respective anomaly scores S1, . . . , Sn of the N anomaly detection models Mn 130 may be determined beforehand. By way of example, typical scenarios of the monitored device 142 may be used to determine the respective anomaly scores S1, . . . , Sn, such typical scenarios including a state of proper operation and to typical failure modes of the device 142. This may allow such typical scenarios of the respective device 142 to be identified if corresponding input data 140 is received.

In some examples, the determined respective anomaly scores s1, . . . , sn for an incoming data batch X may not fit well to the given respective anomaly scores S1, . . . , Sn so that the respective anomaly scores differ from each other and the respective determined difference is larger than the difference threshold. Such a situation may occur due to a distribution drift of the input data and may indicate that the used anomaly detection models Mn 130 may no longer work well for the input data 140 of the respective device 142. In this case, the alarm 150 is generated and provided to a user, the respective device 142, and/or the IT system connected to the respective device 140.

By way of example, the input data 140 includes data on a number of variables, and there are n anomaly detection models Mn reflecting n different scenarios, with n>1 (e.g., one acceptable status scenario and n−1 different damage scenarios).

Further, trained anomaly detection models Mn 130 with n>1 may correspond to supervised learning (SL), a machine learning task of learning a function that maps an input to an output based on example input-output pairs. Such supervised learning infers a function from labeled training data consisting of a set of training examples. In supervised learning, each example is a pair consisting of an input object (e.g., a vector) and a desired output value (e.g., the supervisory signal). A supervised learning algorithm analyzes the training data and produces an inferred function that may be used for mapping new examples. An optimal scenario will allow for the algorithm to correctly determine the class labels for unseen instances. This requires the learning algorithm to generalize from the training data to unseen situations in a “reasonable” way (see inductive bias).

The N anomaly detection models Mn 130 (e.g., trained or untrained) may then be used to determine the respective anomaly scores sn for the respective incoming data batch X relating to the at least N separable classes. Further, the N anomaly detection models Mn 130 (e.g., trained or untrained) may be applied to the input data 140 to generate the output data 152 that is suitable for analyzing, monitoring, operating, and/or controlling the respective device 142. Based on the determined respective anomaly scores sn, by comparing the determined respective anomaly scores sn with given respective anomaly scores Sn of the anomaly detection models Mn 130, an alarm 150 may be generated and provided to a user, the respective device 142, and/or an IT system connected to the respective device 142. The alarm 150 relating to the determined difference may be provided to a user, (e.g., monitoring or supervising a production process involving the device 142 so that he or she may trigger further analysis of the device 142 or the related production step). In some examples, the alarm 150 may be provided to the respective device 142 or to the IT system, for example, and scenarios in which the respective device or the IT system may be or include a SCADA, MOM, or MES system.

The determined anomaly scores sn of the anomaly detection models Mn 130 may be interpreted in terms of trustworthiness of the anomaly detection models Mn 130. In other words, the determined anomaly scores sn may indicate whether the anomaly detection models Mn 130 are trustworthy or not. By way of example, the generated alarm 150 may include the determined anomaly scores sn or an information on the trustworthiness (e.g., level of trustworthiness) of the anomaly detection models Mn 130.

Further, in some examples, outliers with respect to the input data 140 may be allowed so that not each and every input data 140 may trigger an alarm 150. For example, the alarm 150 may only be provided if the determined difference is greater than the given difference threshold for a given number z of sequentially incoming data batches X.

As already mentioned above, the system 100 illustrated in FIG. 1 may correspond or include the computation unit 124. Further, the system 100 may include a first interface 170 for receiving input data messages 140 relating to at least one variable of the at least one device 142, and a second interface 172 for providing an alarm 150 relating to the determined difference to a user, to the respective device 142 and/or an IT system connected to the respective device 142, if the determined difference is greater than the difference threshold. Depending on to which device or system the alarm 150 is sent, the first interface 170 and the second interface 172 may be the same interface or different interfaces. In some examples, the first interface 170 and/or the second interface 172 may be comprised by the computation unit 124.

In some examples, the input data 140 undergoes a distribution drift involving an increase of the determined difference.

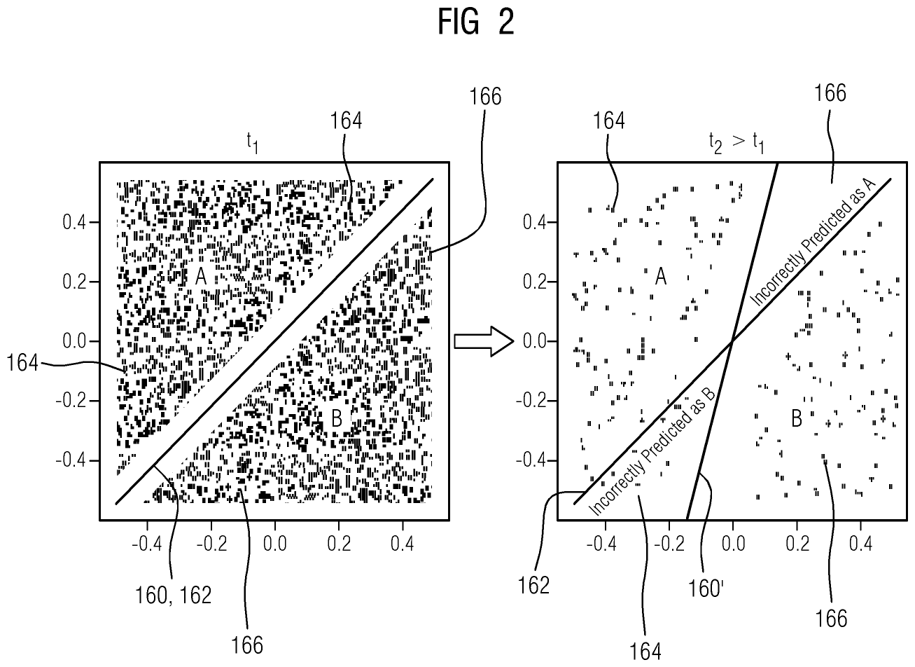

By way of example, the input data 140 includes a variable, where for a given period of time, the values of this variable oscillate around a given mean value. At a later time, the values of this variable oscillate around a different mean value so that a distribution drift has occurred. The distribution may, in many examples, involve an increase of the determined difference and between the anomaly scores sn and Sn. By way of example, a distribution drift of a variable may occur due to wear, ageing, or other sorts of deterioration (e.g., for devices that are subject to mechanical or stress). The concept of a distribution drift leading to an increased difference is explained in more details below in the context of FIG. 2.

In some examples, the suggested methods may hence detect an increase of the difference due to a distribution drift of input data 140.

In some examples, the application software component 106 and/or the processor 102 may further be configured to: determine a distribution drift of the input data 140 if a second difference between the anomaly scores s1, . . . , sn of an earlier incoming data batch Xe and the anomaly scores s1, . . . , sn of a later incoming data batch Xl is greater than a second threshold; and provide a report relating to the determined distribution drift to a user, the respective device 142, and/or an IT system connected to the respective device 142 if the determined second difference is greater than a second threshold.

In these examples, trends of the input data 140 may be used to identify a distribution drift. The second difference is determined taking into account an earlier incoming data batch Xe and a later incoming data batch Xl of the input data 140. This second difference is compared with the second threshold to determine whether the report is to be provided. For example, the respective anomaly scores s1, . . . , sn of both the earlier incoming data batch Xe and the later incoming data batch Xl involve a difference with respect to the given respective anomaly scores S1, . . . , Sn that is smaller than the difference threshold. The second difference may be greater than the second threshold so that a report is generated and provided to the user, the respective device 142, and/or the IT system connected to the respective device 142. In some examples, the second threshold may be equal to the difference threshold, and the respective anomaly scores of the earlier incoming data batch Xe and the later incoming data batch Xl may constitute acceptable deviations at the upper border and lower border of the difference threshold, but the second difference may still be greater than a second threshold. In such cases, this may occur when dynamic changes happen at the respective device 142, such as a complete malfunction or break of some electric or mechanical component of the respective device 142. By way of example, a number of earlier incoming data batches Xi and a number of later incoming data batches Xl may be considered so that singular occurrences of outliers may be sorted out and does not lead to the generation and provision of the report. In further examples, the report may correspond to the above-mentioned alarm 150. Further, in other examples, the anomaly scores s1, . . . , sn of the earlier incoming data batches Xe may correspond to the given anomaly scores S1, . . . , Sn, which may allow for a more dynamic process of generating an alarm 150.

In some examples, the application software component 106 and/or the processor 102 may further be configured to assign training data batches Xt to the at least N separable classes of the anomaly detection models Mn 130 and to determine the given anomaly scores S1, . . . , Sn of the at least N separable classes for the N anomaly detection models Mn 130.

In these examples, the anomaly detection models Mn 130 may be considered as trained functions, whereby the training may be done using an artificial neural network, machine learning techniques, or the like. In some examples, the anomaly detection models Mn 130 may be trained such that a determination whether a respective incoming data batch X belongs to the n-th class or to any of the other N−1 classes using N anomaly detection models Mn 130 is enabled. By way of example, an anomaly detection model (e.g., suitable anomaly detection model) that may distinguish between data distributions belonging to class 1 or any of the other N−1 classes may be trained. Then, another anomaly detection model may be trained. The other anomaly detection model may distinguish between data distributions belonging to class 2 and any of the other N−1 classes. This process may be repeated for the other N−2 classes.

Having ground truth Y={1, 2, . . . , N}, N anomaly detection models may be trained for every class belonging to Y. After step 1, M1, M2, . . . Mn anomaly detection models that may predict whether a streamed data batch X of input data 140 belongs to class 1 or to any of the other N−1 classes, to class 2 or to any of the other N−1 classes, etc. may be obtained.

Utilizing the trained anomaly detection models Mn, descriptive statistics may be obtained for the anomaly scores s1, s2, . . . sn that every model may output for its class on the training dataset or training data batches Xt.

For example, there are training data batches Xt that may be considered as ground truth Y. The input may include data points X, such as data points to be classified (e.g., a training data set or historical data), the ground truth Y (e.g., a label of data point), such as product from which data points originate, and a model M. The data batches X and the ground truth Y may be related to each other via a function.

In some examples, N=1. Hence, there is only one “separable” clause and only one anomaly detection model.

This situation may correspond to an example of unsupervised learning (UL) that is a type of algorithm that learns patterns from untagged data. The hope is that, through mimicry, the machine is forced to build a compact internal representation of its world and then generate imaginative content. In contrast to supervised learning (SL) where data is tagged, for example, by a human (e.g., as “car” or “fish” etc.), UL exhibits self-organization that captures patterns as neuronal predilections or probability densities. The other levels in the supervision spectrum are reinforcement learning where the machine is given only a numerical performance score as its guidance, and semi-supervised learning where a smaller portion of the data is tagged. Two broad methods in UL are Neural Networks and Probabilistic Methods.

Hence, for the incoming data batches X of the input data 140, it is whether the monitored device 142 is in an “okay” state of normal operation or in a “not okay” date of our normal operation. By way of example, no further features, such as typical error or malfunction scenarios of the device 142 may be identified or determined.

The unsupervised scenario with N=1 may be considered as a border case of supervised settings when initial dataset belongs to only one class so that there is only one anomaly detection model Mn 130. Such an unsupervised scenario with N=1 typically implies that there are no labels available for the incoming batches X of the input data 140.

In further examples, the application software component 106 and/or the processor 102 may further be configured, if the determined difference is smaller than the difference threshold, to embed the respective N anomaly detection models Mn 130 in a software application for analyzing, monitoring, operating, and/or controlling the at least one device 142, and to deploy the software application on the at least one device 142 or an IT system connected to the at least one device 142 such that the software application may be used for analyzing, monitoring, operating, and/or controlling the at least one device 142.

The software application may, for example, be a condition monitoring application to analyze and/or money for the status of the respective device 142 or of a production step carried out by the respective device 142. In some examples, the software application may be an operating application or a control application to operate or control the respective device 142 or the production step carried out by the respective device 142. The respective N anomaly detection models Mn 130 may be embedded in such a software application, for example, to derive status information of the respective device 142 or the respective production step order to derive operating or control information for the respective device of the respective production step. The software application may then be deployed on the respective device 142 or the IT system. The software application may then be provided with the input data 140, which may be processed using respective N anomaly detection models Mn 130 to determine the output data 152.

In some examples, a software application may be understood as deployed if the activities that are required to make this software application available for use on the respective device 142 or the IT system (e.g., by a user using the software application on the respective device 142 or the IT system) are provided. The deployment process of the software application may include a number of interrelated activities with possible transitions between them. These activities may occur at the producer side (e.g., by the developer of the software application) or at the consumer side (e.g., by the user of the software application) or both. In some examples, the app deployment process may include at least the installation and the activation of software application, and optionally also the release of the software application. The release activity may follow from the completed development process and is sometimes classified as part of the development process rather than deployment process. The release activity may include operations required to prepare a system (e.g., the processing system 100 or computation unit 124) for assembly and transfer to the computer system(s) (e.g., the respective device 142 or the IT system) on which the release activity will be run in production. Therefore, this may sometimes involve determining the resources required for the system to operate with tolerable performance and planning and/or documenting subsequent activities of the deployment process. For simple systems, the installation of the software application may involve establishing some form of command, shortcut, script, or service for executing the software (e.g., manually or automatically) of the software application. For complex systems, the installation may involve configuration of the system, possibly by asking the end user questions about its intended use, or directly asking the end user how the end user would like the system to be configured, and/or making all the required subsystems ready to use. Activation may be the activity of starting up the executable component of software application for the first time (which is not to be confused with the common use of the term activation concerning a software license, which is a function of Digital Rights Management systems.)

In some examples, the application software component 106 and/or the processor 102 may further be configured, if the determined difference is greater than the difference threshold, to amend the respective anomaly detection models Mn 130 such that a determined difference using the respective amended anomaly detection models Mn 130 is smaller than the difference threshold, to replace the respective anomaly detection models Mn 130 with the respective amended anomaly detection models Mn 130 in the software application, and to deploy the amended software application on the at least one device 142 or the IT system.

If the determined difference is greater than the difference threshold, the respective anomaly detection models Mn 130 may be amended, for example, by introducing an offset or factor with respect to the variable, so that the difference using the respective amended anomaly detection models Mn 130 is smaller than the difference threshold. For determining the difference using the amended trained function, the same procedure may apply as for respective anomaly detection models Mn 130 (e.g., determining respective anomaly scores s1, . . . , sn for the respective incoming data batch X relating to the at least N separable classes using the respective amended N detection models Mn 130). By way of example, the respective amended N detection models Mn 130 may be found by varying the parameters of the respective N detection models Mn 130 and calculating the corresponding amended difference. If the amended difference for a given set of varied parameters is smaller than the difference threshold, varied parameters may be used in the amended respective amended N detection models Mn 130 that comply with the difference threshold.

In some examples, amending the respective N detection models Mn 130 may already be triggered at the slightly lower, first difference threshold corresponding to a higher trustworthiness. Hence, the respective N detection models Mn 130 may still result in acceptable quality for analyzing, monitoring, operating, and/or controlling the respective device 142, although having better, respective amended N detection models Mn 130 may be desirable. In such a case, amending the respective N detection models Mn 130 may already be triggered to obtain an improved, amended respective amended N detection models Mn 130 leading to a lower amended difference. Such an approach may allow for always having respective N detection models Mn 130 with a high trustworthiness, including scenarios with a data distribution drift (e.g., related to wear, ageing, or other sorts of deterioration). Using the slightly lower, first difference threshold may take into account a certain latency between an increasing difference for the respective N detection models Mn 130 and determining amended respective amended N detection models Mn 130 with a lower difference and hence higher trustworthiness. Such a scenario may correspond to an online retraining or permanent retraining of the respective N detection models Mn 130.

In the software application, the respective N detection models Mn 130 may then be replaced with the respective amended N detection models Mn 130, which may then be deployed at the respective device 142 or the IT system.

In further examples, the application software component 106 and/or the processor 102 may further be configured, if the amendment of the anomaly detection models takes more time than a duration threshold, to replace the deployed software application with a backup software application and to analyze, monitor, operate, and/or control the at least one device 142 using the backup software application.

In some examples, suitably amending the respective N detection models Mn 130 may take longer time than a duration threshold. This may, for example, occur in the previously mentioned online retraining scenarios if there is a lack of suitable training data or if there are limited computation capacities. In such cases, a backup software application may be used to analyze, monitor, operate, and/or control the respective device 142. The backup software application may, for example, put the respective device 142 in a safety mode to, for example, avoid damages or harm to persons or to a related production process. In some examples, the backup software application may shut down the respective device 142 or the related production process. In further examples involving, for example, a collaborated robot or other devices 142 that are intended for direct human robot/device interaction within a shared space, or where humans and robots/devices are in close proximity, the application may switch the corresponding device 142 to a slow mode, thereby also avoiding harm to persons. Such scenarios may, for example, include car manufacturing plants or other manufacturing facilities with production or assembly lines in which machines and humans work in a shared space and in which the backup software application may switch the production or assembly line to such a slow mode.

In some examples, for a plurality of interconnected devices 142, the application software component 106 and/or the processor 102 may further be configured to: embed a respective N detection models Mn 130 in a respective software application for analyzing, monitoring, operating, and/or controlling the respective interconnected device(s) 142; deploy the respective software application on the respective interconnected device(s) 142 or an IT system connected to the plurality of interconnected devices 142, such that the respective software application may be used for analyzing, monitoring, operating, and/or controlling the respective interconnected device(s) 142; determine a respective difference using the respective anomaly detection models Mn 130; and if the respective, determined difference is greater than a respective difference threshold, provide an alarm 150 relating to the determined difference and the respective interconnected device(s) 142 for which the corresponding respective software application used for analyzing, monitoring, operating, and/or controlling the respective interconnected device(s) 142 to a user, the respective device 142, and/or an automation system.

The interconnected devices 142 may, by way of example, be part of a more complex production or assembly machine or even constitute a complete production or assembly plant. In some examples, a plurality of respective anomaly detection models Mn 130 is embedded in a respective software application to analyze, monitor for, operate, and/or control one or more of the interconnected devices 142. The respective anomaly detection models Mn 130 and the corresponding devices 142 may interact and cooperate. In such scenarios, it may be challenging to identify the origin of problems that may occur during the operation of the interconnected devices 122. In order to overcome such difficulties, the respective difference using the respective anomaly detection models Mn 130 is determined, and if the respective, determined difference is larger than a respective difference threshold, an alarm 152 that relates to the respective, determined difference and the respective interconnected device(s) 142 may be provided. This approach allows for a root cause analysis in a complex production environment involving a plurality of respective anomaly detection models Mn 130 that are embedded in corresponding software applications deployed on a plurality of interconnected devices 142. Hence, a particularly high degree of transparency is achieved, allowing for fast and efficient identification and correction of errors. By way of example, in such a complex production environment, a problematic device 142 among the plurality of interconnected devices 142 may easily be identified, and by amending the respective anomaly detection model Mn 130 of this problematic device 142, the problem may be solved.

In the context of these examples, there may be scenarios with one set of respective anomaly detection models Mn 130 for each device 142, with a plurality of respective anomaly detection models Mn 130 for each device 142, or with a plurality of respective anomaly detection models Mn 130 for a plurality of devices 142. Hence, there may be a one-to-one correspondence, a one-to-many correspondence, a many-to-one correspondence, or a many-to-many correspondence between respective anomaly detection models Mn 130 and devices 142.

In further examples, the respective device 142 is any one of a production machine, an automation device, a sensor, a production monitoring device, a vehicle, or any combination thereof.

As already mentioned above, the respective device 142 may, in some examples, be or include a sensor, an actuator, such as an electric motor, a valve, or a robot, and inverter supplying an electric motor, a gear box, a programmable logic controller (PLC), a communication gateway, and/or other parts component relating to industrial automation products and industrial automation in general. The respective device 142 may be or may be part of a complex production line or production plant (e.g., a bottle filing machine, conveyor, welding machine, welding robot, etc.). Further, by way of example, the respective device may be or include a manufacturing operation management (MOM) system, a manufacturing execution system (MES), an enterprise resource planning (ERP) system, a supervisory control and data acquisition (SCADA) system, or any combination thereof.

In an industrial embodiment, the suggested method and system may be realized in the context of an industrial production facility (e.g., for producing parts of product devices, such as printed circuit boards, semiconductors, electronic components, mechanical components, machines, devices, vehicles, or parts of the vehicle's, such as cars, cycles, airplanes, ships, or the like) or an energy generation or distribution facility (e.g., power plant in general, transformers, switch gears, the like). By way of example, the suggested method and system may be applied to certain manufacturing steps during the production of the product device, such as milling, grinding, welding, forming, painting, cutting, etc. (e.g., monitoring or even controlling the welding process, such as during the production of cars). For example, the suggested method and system may be applied to one or a number of plants performing the same task at different locations, whereby the input data may originate from one or a number of these plants that may allow for a particularly good database for further improving the respective anomaly detection models Mn 130 and/or the quality of the analysis, the monitoring, the operation, and/or the control of the device 142 or plant(s).

Here, the input data 140 may originate from devices 142 of such facilities (e.g., sensors, controllers, or the like), and the suggested method and system may be applied to improve analyzing, monitoring, operating, and/or controlling the device 142 or the related production or operation step. To this end, the respective anomaly detection models Mn 130 may be embedded in a suitable software application that may then be deployed on the device 142 or a system (e.g., an IT system), such that the software application may be used for the mentioned purposes.

In some examples, convergence of the mentioned training is not an issue so that no stop criteria may be needed. This may be due to the respective anomaly detection models Mn 130 being analytical functions, and only a finite number of iteration steps may be required. Concerning the artificial neural network, the minimum number of nodes generally may depend on specifics of the algorithm, whereby in some examples, for the present embodiments, a random forest may be used. Further, the minimum number of nodes of the used artificial neural network may depend on the number of dimensions of the input data 140 (e.g., two dimensions, such as for two separate forces) or 20 dimensions (e.g., for 20 corresponding physical observable tabular data or timeseries data).

In an example embodiment, one or more of the following acts may be used: 1) Receive input data including incoming data points X (e.g., data points to be classified−training set=historical data), optionally ground truth Y (e.g., =label of data point, e.g. product from which data points originates) and model M, where X and Y are related to each other via function; optionally, put the input in some storage (e.g., buffer or low access-time storage allowing for a desired sampling frequency), where the data points may include information on one or a number of variables, such as sensor data with respect to electric current, electric voltage, temperature, noise, vibration, optical signals, or the like; 2) optionally (e.g., if trained anomaly detection model not yet available), train suitable anomaly detection model that may distinguish between data distribution belonging to class 1 and not to any of other N−1 classes; 3) optionally (e.g., if trained anomaly detection model not yet available), train another model to distinguish data distribution belonging to class 2 and not to any of other N−1 classes, etc.; 4) having ground truth, train N anomaly detection models for every class belonging to Y. After act 1), M1, M2, . . . Mn anomaly detection models that may predict either a streamed batch of data belongs to class 1 or to any of other N−1 classes (e.g., to class 2 or to any of other N−1 classes, etc.) are provided. One or more of the following acts may also be provided: 5) Utilizing trained anomaly detection models, descriptive statistics are obtained for anomaly scores s1, s2, . . . sn that every model outputs for its class on training dataset; 6) for every new and previously unseen batch of incoming data, descriptive statistics of anomaly scores si are output and compared against corresponding descriptive statistics si obtained for every model M1, M2, . . . Mn; 7) new obtained anomaly scores are compared against reference anomaly scores obtained on initial data. If significantly different, data distribution drift is detected, and a warning that trained AI model may not be trustworthy anymore is sent.

Optionally, the report may include the indication “warning” if the determined difference value is larger than a first threshold (e.g., accuracy<98%; difference>2%). Then, collecting data may be started, the collected data may be data labelled (e.g., in a supervised case), and the use case machine learning model (e.g., the trained anomaly detection model) may be adopted. If the determined difference value is larger than a first threshold (e.g., accuracy<95%, difference>5%), the report may include the indication “error”, and the use case machine learning model (e.g., the trained anomaly detection model) may be replaced with the amended use case machine learning model (e.g., the amended trained anomaly detection model)

The embodiment along with the present embodiments have a number of advantages including: Fully automatic detection of a data distribution drift after artificial intelligence (AI) model is deployed; no ground truth is required; do not have to concentrate on computing possible contributors to the data distribution drift and employ all dimensions of a dataset and therefore more robust to multidimensional datasets. Further, the suggested solution is independent of a number of variables and may be utilized with a proper constructed feature.

In a more refined embodiment, the following considerations may apply. In order to detect a data distribution drift, machine learning techniques that are typically used for anomaly detection may be utilized. However, for the sake of generalization, one can employ any other suitable method that performs the detection of anomalies. The following settings may be covered: 1) AI task is resolved in supervised settings (e.g., initial training data are supplied by ground truth); and 2) AI task is resolved in unsupervised settings (e.g., initial training data have no ground truth)

### 1) Supervised Settings

The AI task is formulated as follows: having data points X and ground truth Y={1, 2, . . . N}, an analytical model that is able to build a decision boundary that separates streaming data between different classes 1, 2, . . . N is wanted. For this purpose, a Machine Learning model is trained or any other analytical technique is used for obtaining a model M. Model M plays a role as, for example, a function of predictors X outputting predictions belonging to one of N classes from Y. Therefore, a general model M that may distinguish between different data distributions within a training dataset is obtained. However, every time data that was not included in the initial training dataset is input, this model may fail. In order to detect this, it is to be determined that incoming data distribution differs from all data distributions the model has seen before. To perform such a detection, any suitable anomaly detection model that may distinguish between data distribution belonging to class 1 and not to any of other N−1 classes is trained. Then, another model is trained to distinguish data distribution belonging to class 2 and not to any of other N−1 classes, etc.

The following workflow is established. Having ground truth, N anomaly detection models are trained for every class belonging to Y. After step 1, M1, M2, . . . Mn anomaly detection models that may predict either a streamed batch of data belongs to class 1 or to any of other N−1 classes are provided to class 2 or to any of other N−1 classes, etc. Trained anomaly detection models are utilized, and descriptive statistics may be obtained for anomaly scores s1, s2, . . . sn that every model outputs for its class on training dataset. Such descriptive statistics may be: median values of s1, s2, . . . sn, standard deviation, IQR, etc. For every new and previously unseen batch of incoming data, descriptive statistics of anomaly scores si are output and compared against corresponding descriptive statistics si obtained for every model M1, M2, . . . Mn.

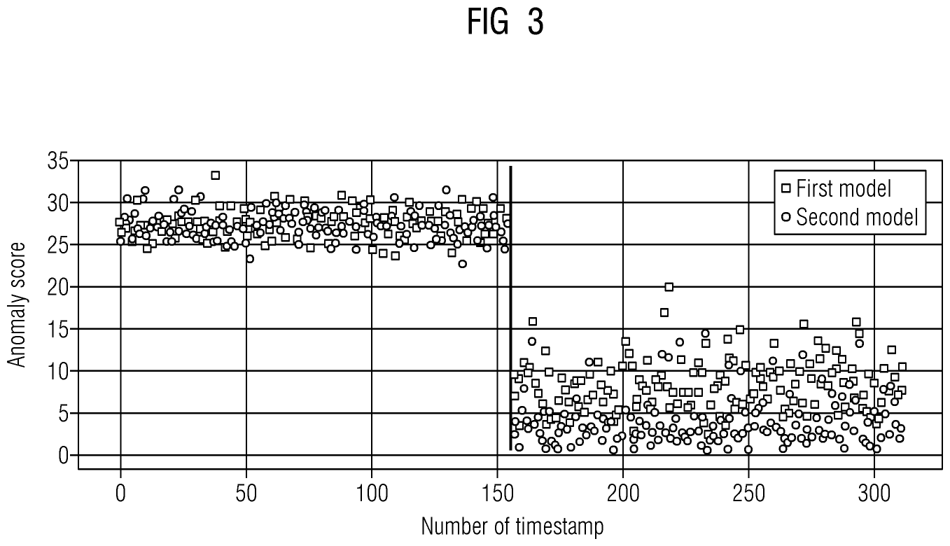

An example of this method being utilized for a binary classification problem is shown in FIG. 3. The first model M1 has been trained with data belonging only to class 1 of our initial dataset (e.g., “first model”, squares in FIG. 3), and the model M2 was trained on data belonging to class 2 (e.g., “second model”, circles in FIG. 3). After training these two models, anomaly scores on subsets are obtained belonging to class 1 and class 2. These anomaly scores are denoted as s1 and s2 and are distributed between timestamps 0 and 157. The median values of s1(0-156) and s2(0-156) together is 27.4. At timestamp 157, data belonging to other distributions stared streaming and a check against the trained models M1 and M2 has been done. These anomaly scores are distributed between timestamp 157 and 312 and may be denoted as s1(157-312) s2(157-312). The median value of anomaly score distribution in this case is 5.4. For this example, only one descriptive statistic was used, which is a median value of s. As illustrated in FIG. 3, the data distribution drift at timestamp 157 is shown.

In order to introduce robustness to the suggested method, descriptive statistics are considered for s as distributions itself, and for this reason, distributions of s are drawn for comparison. These distributions are shown in FIG. 4.

Anomaly scores are mostly consolidated in the left box, which is one modal distribution with a median value 27.4 and has 4 outliers. The left box consolidates most of the data under data distribution drift with a median value 5.4 and 2 outliers. These two distributions are perfectly separable, and a data distribution drift is shown. However, in case when these distributions are not perfectly separable, a statistical testing is employed with a following hypothesis: H0—the distributions of s are the same; H1-H0 is incorrect.

### 2) Unsupervised Case

The suggested method may treat unsupervised settings as a border case of supervised settings when the initial dataset belongs only to one class. In this case, everything described above is applicable and valid. The number of anomaly detection models collapses to 1.

Sending an alarm

Having trained the initial model and models for data drift detection, the anomaly detection model(s) may be deployed, and anomaly scores may be monitored in an automated way crosschecking new obtained anomaly scores against reference anomaly scores obtained on initial data. If, as described previously, a new obtained anomaly score distribution is significantly different to reference distribution of anomaly scores, a data distribution drift is detected and a warning that trained AI model (e.g., the respective trained anomaly detection model Mn may not be trustworthy anymore) may be sent.

In order to avoid (unnecessary) false positives, the following workflow may be provided: Having a trained AI model and anomaly detection models, these are deployed; start data stream; for every incoming batch of data, the method described above is applied and new anomaly scores are obtained; if the distribution of newly obtained anomaly scores significantly differs from a reference distribution for N incoming batches of streaming data sequentially, the user is warned that data distribution drift occurs.

If the difference in anomaly score distributions occurs not in sequential order or suddenly, the difference may be ignored and treated as an outlier.

In comparison with other approaches, the suggested method offers the following advantages. For detection of a data distribution drift after AI model is deployed, ground truths are not needed, and the detection is performed in a fully automated way. The suggested solution does not concentrate on computing possible contributors to the data distribution drift and employs all dimensions of a dataset and is therefore more robust to multidimensional datasets. Further, the solution is independent of a number of variables and may be utilized with a proper constructed feature. The methods of other approaches use one dimensional distances and expensive computations for calculations. In order to detect the data distribution drift, these methods suggest setting a threshold manually based on empirical knowledge, which has a disadvantage in having a large number of false positives and/or false negatives. Another disadvantage is the manual step that is hard to automate. Most of the indicated competitors are operating in the e-commerce area and/or computer vision area and therefore are providing solutions mostly based on certain use cases. The suggested method is applicable to a huge extend in a fully automized way, for tabular and time series data, and for supervised and unsupervised settings. Other approaches often rely on hand crafted thresholds, which are use case and data specific and may lead to a huge amount of false positive/false negative detections. The suggested method is based on AI techniques, and the monitoring and decision making is performed in a fully automated way. This approach replaces manual threshold monitoring and provides space for scaling and generalizability.

In general, the suggested method provides better performance and efficiency. Additionally, a robustness of the suggested method may be increased by performing a statistical testing. The suggested method is more robust to usage in a multidimensional dataset together with a possibility to reduce the dimensionality. Being deployed is fully automated. The suggested method is computationally efficient and may be run at any suitable edge device. The suggested method fits to a wide range of products and solutions.

In an industrial embodiment, the suggested method and system may be realized in the context of an industrial production facility (e.g., for producing parts of devices, such as printed circuit boards, semiconductors, electronic components, mechanical components, machines, devices, vehicles or parts of the vehicle's, such as cars, cycles, airplanes, ships, or the like) or an energy generation or distribution facility (e.g., power plant in general, transformers, switch gears, the like). By way of example, the suggested method and system may be applied to certain manufacturing steps during the production of the device, such as milling, grinding, welding, forming, painting, cutting, etc. (e.g., monitoring or even controlling the welding process during the production of cars). For example, the suggested method and system may be applied to one or a number of plants performing the same task at different locations, whereby the input data may originate from one or a number of these plants that may allow for a particularly good database for further improving the train model and/or the quality of the analysis, the monitoring, the operation, and/or the control of the device or plant(s).

The input data may originate from devices of such facilities (e.g., sensors, controllers, or the like), and the suggested method and system may be applied to improve analyzing, monitoring, operating, and/or controlling the device. To this end, the train function may be embedded in a suitable software application that may then be deployed on the device or a system (e.g., an IT system), such that the software application may be used for the mentioned purposes.

By way of example, the device input data may be used as input data, and the device output data may be used as output data.

FIG. 2 illustrates a degradation of a model in time due to a data distribution shift. Herein, the model may correspond to the respective anomaly detection models Mn 130, where the model (e.g., anomaly detection model) may be a trained model.

In an ideal situation, a model (e.g., trained on acquired data) is to perform excellent on an incoming stream of data. However, an analytical model degrades with a time and a model trained at time t₁ may perform worse at time t₂.

For purposes of illustration, a binary classification between classes A and B for two-dimensional datasets are considered. At time t₁, a data analyst trains a model that is able to build a decision boundary 162 between data belonging to either class A (cf. data point 164) or class B (cf. data points 166). In this case, a build decision boundary 162 corresponds to a real boundary 160 that separates these two classes. At the time being deployed, a model generally performs excellent. However, at later time t₂>t₁, an incoming data stream or input data messages 140 may experience a drift in a data distribution and by this, may have an effect on performance of the model. This phenomenon is illustrated on the right-hand side of FIG. 2: data points 166 belonging to class B drift towards the right lower corner, and data points 164 belonging to class A drift in an opposite direction. Therefore, a previous build decision boundary 162 does not correspond to new data distributions of classes A and B since the new, real boundary 160′ separating two classes has moved. Hence, the analytical model is to be retrained or updated otherwise as soon as possible.

Among others, one goal of the suggested approach may include to develop a method for detecting a performance drop or decrease of a trained model (e.g., the respective anomaly detection models Mn 130) under data distribution shift in data streams, such as sensor data streams or input data messages 140. In some examples, high data drift alone does not mean bad prediction accuracy of a trained model (e.g., the respective anomaly detection models Mn 130). It may finally be necessary to correlate this drift with the ability of the old model to handle the data drift (e.g., measure the current accuracy). In some examples, once a performance drop or greater difference is detected, the data analyst may retrain the model based on new character of incoming data.

FIG. 3 illustrates an exemplary data distribution drift detection for a binary classification task (cf. explanation above).

FIG. 4 illustrates an exemplary boxplot that compares two distributions of anomaly scores (cf. explanation above).

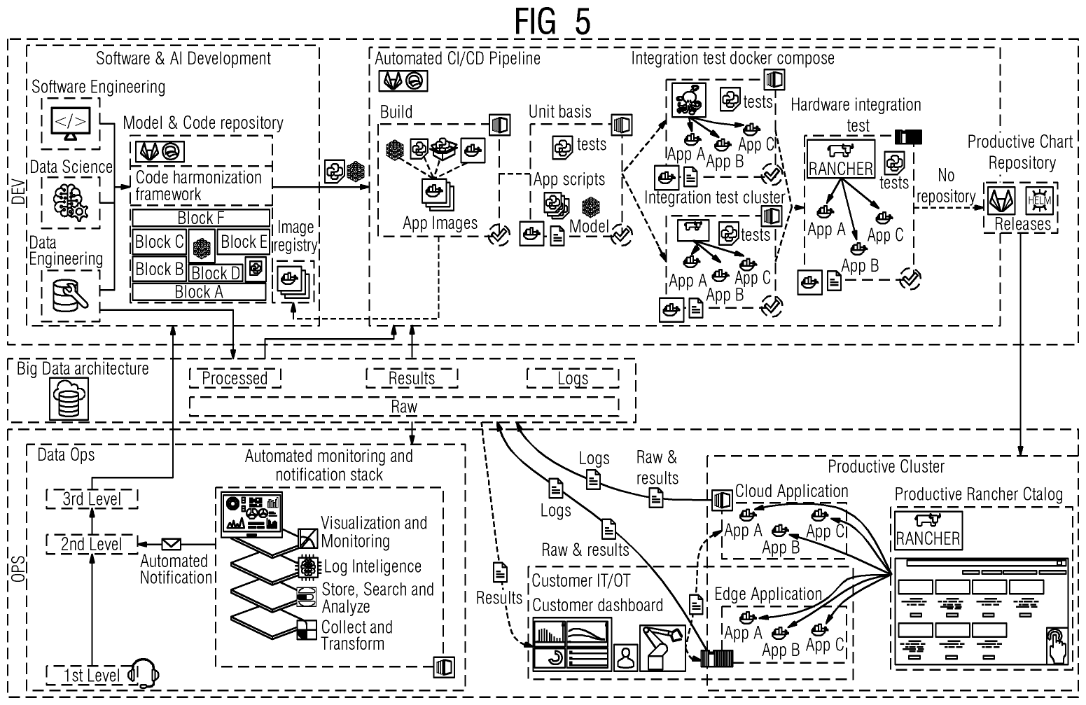

FIG. 5 illustrates a functional block diagram of an example system that facilitates providing an alarm and managing computer software products in a product system.

The overall architecture of the illustrated example system may be divided in development (“dev”), operations (“ops”), and a big data architecture arranged in between development and operations. Herein, dev and ops may be understood as in DevOps, a set of practices that combine software development (Dev) and IT operations (Ops). DevOps aims to shorten the systems development life cycle and provide continuous delivery with high software quality. By way of example, the anomaly detection model(s) explained above may be developed or refined and then be embedded in a software application in the “dev” area of the illustrated system, whereby the anomaly detection model(s) of the software application is then operated in the “ops” area of the illustrated system. The overall idea is to enable adjusting or refining the anomaly detection model(s) or the corresponding software solution based on operational data from the “ops” that may be handled or processed by the “big data architecture”, whereby the adjustment or refinement is done in the “dev” area.

On the bottom right (e.g., in the “ops” area), a deployment tool for apps (e.g., software applications) with various micro services referred to as “Productive Rancher Catalogue” is shown. It allows for data import, data export, a MQTT broker, and a data monitor. The Productive Rancher Catalogue is part of a “Productive Cluster” that may belong to the operations side of the overall “Digital Service Architecture”. The Productive Rancher Catalogue may provide software applications (“Apps”) that may be deployed as cloud applications in the cloud or as edge applications on edge devices, such as devices and machines used in an industrial production facility or an energy generation or distribution facility (as explained in some detail above). The micro services may, for example, represent or be comprised in such applications. The devices on which the corresponding application is running (or the application running on the respective device) may deliver data (e.g., sensor data, control data, etc.), as, for example, logs or raw data (or, e.g., input data), to a cloud storage named “Big data architecture” in FIG. 4.

This input data may be used on the development side (“dev”) of the overall Digital Service Architecture to check whether the anomaly detection model(s) (cf. “Your model” in the block “Code harmonization framework” in the block “Software & AI Development”) is still accurate or needs to be amended (cf. determining of the difference and amending the anomaly detection model(s), if the determined difference is above a certain threshold). In the “Software & AI Development” area, there may be templates and AI models, and optionally the training of a new model may be performed. If an amendment is required, the anomaly detection model(s) is/are amended accordingly and during an “Automated CI/CD Pipeline” (CI/CD=continuous integration/continuous delivery or continuous deployment) embedded in an application that may deployed as cloud application in the cloud or as edge application on edge devices when transferred to the Protective Cluster (mentioned above) of the operations side of the overall Digital Service Architecture.

The Automated CI/CD Pipeline may include: Build “Base Image” & “Base Apps”->build App Image and App; unit tests—software tests, machine learning, model testing; integration test (docker on a machine, or cluster, such as Kubernetes cluster); hardware (HW) integration test (deployment on real edge device/edge box); a new Image may be obtained suitable for release/deployment in the Productive Cluster

The described update or amendment of the anomaly detection model(s) may be necessary, for example, if a sensor or device is broken, has a malfunction, or generally needs to be replaced. Also, sensors and devices are ageing so that a new calibration may be required from time to time. Such events may result in anomaly detection model(s) that is/are no more trustworthy, but rather needs to be updated.

The advantage of the suggested method and system embedded in such a Digital Service Architecture is that an update of anomaly detection model(s) may be performed as quick as the replacement of the sensor or a device (e.g., only 15 minutes of recovery time are also needed for programming and deployment of new anomaly detection model(s) and an according application that includes the new anomaly detection model(s)). Another advantage is that the update of deployed anomaly detection model(s) and the corresponding application may be performed fully automatically.

The described examples may provide an efficient way to provide alarm relating to anomaly scores assigned to input data, such as detecting a distribution drift of the incoming data using anomaly detection models, thereby enabling driving the digital transformation and empowering machine learning applications to influence and even maybe shape processes. One important aspect contribution of the present embodiments is that it helps assuring the trustworthiness of such applications in a highly volatile environment on the shop floor. The present embodiments may support handling this challenge by providing a monitoring and alarming system, which helps to react properly, once the machine learning application is not behaving in the way the machine learning application was trained to do. Thus, the described examples may reduce the total cost of ownership of the computer software products in general, by improving their trustworthiness and supporting to keep the computer software products up to date. Such efficient provision of output data and management of computer software products may be leveraged in any industry (e.g., Aerospace & Defense, Automotive & Transportation, Consumer Products & Retail, Electronics & Semiconductor, Energy & Utilities, Industrial Machinery & Heavy Equipment, Marine, or Medical Devices & Pharmaceuticals). Such efficient provision of output data and management of computer software products may also be applicable to a consumer facing the need of trustworthy and up to date computer software products.

For example, the above examples are equally applicable to the computer system 100 arranged and configured to execute the acts of the computer-implemented method of providing output data, to the corresponding computer program product, and to the corresponding computer-readable medium explained in the present patent document, respectively.

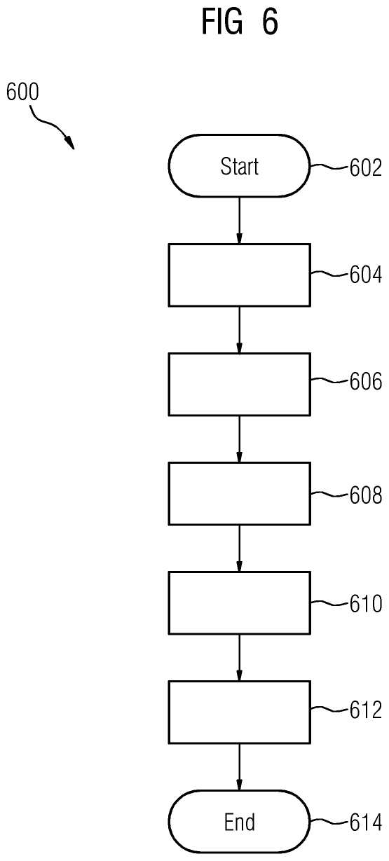

Referring now to FIG. 6, a methodology 600 that facilitates providing an alarm relating to anomaly scores assigned to input data, such as detecting a distribution drift of the incoming data using anomaly detection models is illustrated. The method may start at 602, and the methodology may include a number of acts carried out through operation of at least one processor.

These acts may include an act 604 of receiving input data relating to at least one device, where the input data includes incoming data batches X relating to at least N separable classes, with nϵ1, . . . , N. Act 606 includes determining respective anomaly scores s1, . . . , sn for the respective incoming data batch X relating to the at least N separable classes using N anomaly detection models Mn. In act 608, the (trained) anomaly detection models Mn are applied to the input data to generate output data. The output data is suitable for analyzing, monitoring, operating, and/or controlling the respective device. Act 610 includes determining, for the respective incoming data batch X, a difference between the determined respective anomaly scores s1, . . . , sn for the at least N separable classes and given respective anomaly scores S1, . . . , Sn of the N anomaly detection models Mn (130). If the respective determined difference is greater than a difference threshold, an act 612 of providing an alarm relating to the determined difference to a user, the respective device, and/or an IT system connected to the respective device is provided. At 614, the methodology may end.

The methodology 600 may include other acts and features discussed previously with respect to the computer-implemented method of providing an alarm relating to anomaly scores assigned to input data, such as detecting a distribution drift of the incoming data using anomaly detection models.

For example, the methodology may further include the act of determining a distribution drift of the input data if a second difference between the anomaly scores s1, . . . , sn of an earlier incoming data batch Xe and the anomaly scores s1, . . . , sn of a later incoming data batch Xl is greater than a second threshold. Additionally, an act of providing a report relating to the determined distribution drift to a user, the respective device, and/or an IT system connected to the respective device if the determined second difference is greater than a second threshold may be provided.

In some examples, the methodology may further include the act of assigning training data batches Xt to the at least N separable classes of the anomaly detection models Mn, and an act of determining the given anomaly scores S1, . . . , Sn of the at least N separable classes for the N anomaly detection models Mn.

In some examples, if the determined accuracy value is equal to or greater than the accuracy threshold, the methodology may, if the determined difference is smaller than the difference threshold, further include the act of embedding the N anomaly detection models Mn in a software application for analyzing, monitoring, operating, and/or controlling the at least one device, and an act of deploying the software application on the at least one device or an IT system connected to the at least one device such that the software application may be used for analyzing, monitoring, operating, and/or controlling the at least one device.

In further examples, if the determined difference is greater than the difference threshold, the methodology may further include the act of amending the respective anomaly detection models Mn such that a determined difference using the respective amended anomaly detection models Mn is smaller than the difference threshold, an act of replacing the respective anomaly detection models Mn with the respective amended anomaly detection models Mn in the software application, and an act of deploying the amended software application on the at least one device or the IT system.

In some examples, the methodology may further include, if the amendment of the anomaly detection models takes more time than a duration threshold, an act of replacing the deployed software application with a backup software application and an act of analyzing, monitoring, operating, and/or controlling the at least one device using the backup software application.

In some examples, for a plurality of interconnected devices, the methodology may further include an act of embedding respective N detection models Mn in a respective software application for analyzing, monitoring, operating, and/or controlling the respective interconnected device(s); an act of deploying the respective software application on the respective interconnected device(s) or an IT system connected to the plurality of interconnected devices such that the respective software application may be used for analyzing, monitoring, operating, and/or controlling the respective interconnected device(s); an act of determining a respective difference of the respective anomaly detection models; and, if the respective, determined difference is greater than a respective difference threshold, an act of providing an alarm relating to the determined difference and the respective interconnected device(s) for which the corresponding respective software application used for analyzing, monitoring, operating, and/or controlling the respective interconnected device(s) to a user, the respective device, and/or an automation system.

As discussed previously, acts associated with these methodologies (other than any described manual acts such as an act of manually making a selection through the input device) may be carried out by one or more processors. Such processor(s) may be comprised in one or more data processing systems, for example, that execute software components operative to cause these acts to be carried out by the one or more processors. In an example embodiment, such software components may include computer-executable instructions corresponding to a routine, a sub-routine, programs, applications, modules, libraries, a thread of execution, and/or the like. Further, it should be appreciated that software components may be written in and/or produced by software environments/languages/frameworks such as Java, JavaScript, Python, C, C#, C++, or any other software tool capable of producing components and graphical user interfaces configured to carry out the acts and features described herein.

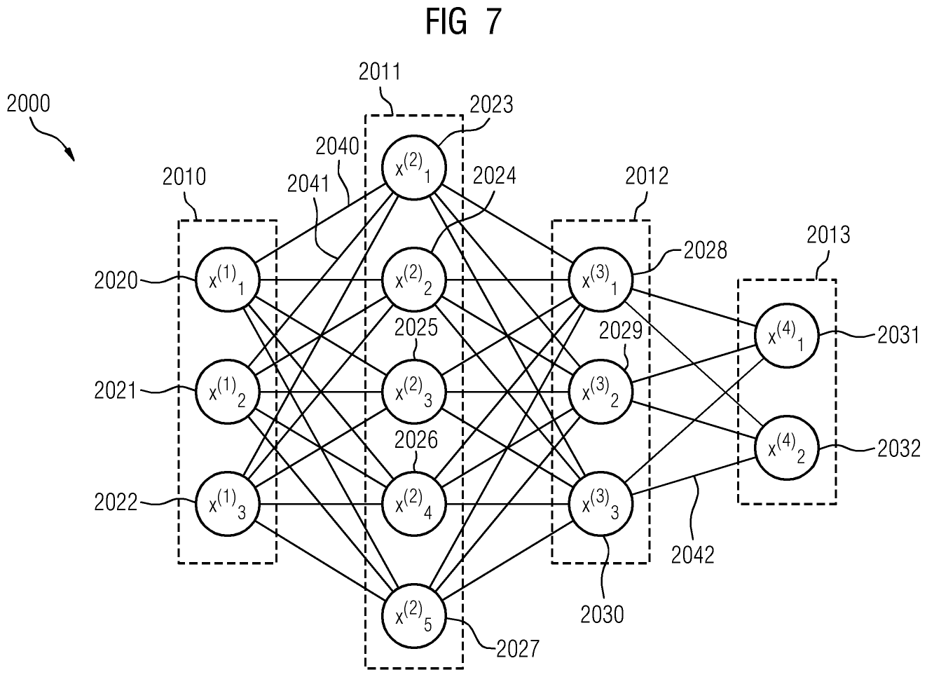

FIG. 7 displays an embodiment of an artificial neural network 2000 that may be used in the context of providing an alarm relating to anomaly scores assigned to input data, such as detecting a distribution drift of the incoming data using anomaly detection models. Alternative terms for “artificial neural network” are “neural network”, “artificial neural net”, or “neural net”.

The artificial neural network 2000 includes nodes 2020, . . . , 2032 and edges 2040, . . . , 2042, where each edge 2040, . . . , 2042 is a directed connection from a first node 2020, . . . , 2032 to a second node 2020, . . . , 2032. In general, the first node 2020, . . . , 2032 and the second node 2020, . . . , 2032 are different nodes 2020, . . . , 2032. It is also possible that the first node 2020, . . . , 2032 and the second node 2020, . . . , 2032 are identical. For example, in FIG. 6, the edge 2040 is a directed connection from the node 2020 to the node 2023, and the edge 2042 is a directed connection from the node 2030 to the node 2032. An edge 2040, . . . , 2042 from a first node 2020, . . . , 2032 to a second node 2020, . . . , 2032 is also denoted as “ingoing edge” for the second node 2020, . . . , 2032 and as “outgoing edge” for the first node 2020, . . . , 2032.

In this embodiment, the nodes 2020, . . . , 2032 of the artificial neural network 2000 may be arranged in layers 2010, . . . , 2013, where the layers may include an intrinsic order introduced by the edges 2040, . . . , 2042 between the nodes 2020, . . . , 2032. For example, edges 2040, . . . , 2042 may exist only between neighboring layers of nodes. In the displayed embodiment, there is an input layer 2010 including only nodes 2020, . . . , 2022 without an incoming edge, an output layer 2013 including only nodes 2031, 2032 without outgoing edges, and hidden layers 2011, 2012 in-between the input layer 2010 and the output layer 2013. In general, the number of hidden layers 2011, 2012 may be chosen arbitrarily. The number of nodes 2020, . . . , 2022 within the input layer 2010 usually relates to the number of input values of the neural network, and the number of nodes 2031, 2032 within the output layer 2013 usually relates to the number of output values of the neural network.

For example, a (real) number may be assigned as a value to every node 2020, . . . , 2032 of the neural network 2000. Here, x(n)i denotes the value of the i-th node 2020, . . . , 2032 of the n-th layer 2010, . . . , 2013. The values of the nodes 2020, . . . , 2022 of the input layer 2010 are equivalent to the input values of the neural network 2000, and the values of the nodes 2031, 2032 of the output layer 2013 are equivalent to the output value of the neural network 2000. Further, each edge 2040, . . . , 2042 may include a weight being a real number (e.g., the weight is a real number within the interval [−1, 20] or within the interval [0, 20]). Here, w^{(m,n)}_{i,j} denotes the weight of the edge between the i-th node 2020, . . . , 2032 of the m-th layer 2010, . . . , 2013 and the j-th node 2020, . . . , 2032 of the n-th layer 2010, . . . , 2013. Further, the abbreviation w⁽ⁿ⁾_{i,j} is defined for the weight w^{(n,n+1)}_{i,j}.

For example, to calculate the output values of the neural network 2000, the input values are propagated through the neural network. For example, the values of the nodes 2020, . . . , 2032 of the (n+1)-th layer 2010, . . . , 2013 may be calculated based on the values of the nodes 2020, . . . , 2032 of the n-th layer 2010, . . . , 2013 by

xⱼ⁽ⁿ⁺¹⁾=f(Σᵢxᵢ⁽ⁿ⁾·w_{i,j}⁽ⁿ⁾)

Herein, the function f is a transfer function (e.g., “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

For example, the values are propagated layer-wise through the neural network. Values of the input layer 2010 are given by the input of the neural network 2000. Values of the first hidden layer 2011 may be calculated based on the values of the input layer 2010 of the neural network. Values of the second hidden layer 2012 may be calculated based in the values of the first hidden layer 2011, etc.

In order to set the values w^{(m,n)}_{i,j} for the edges, the neural network 2000 is to be trained using training data. For example, training data includes training input data and training output data (denoted as tᵢ). For a training step, the neural network 2000 is applied to the training input data to generate calculated output data. For example, the training data and the calculated output data include a number of values. The number is equal to the number of nodes of the output layer.

For example, a comparison between the calculated output data and the training data is used to recursively adapt the weights within the neural network 2000 (e.g., backpropagation algorithm). For example, the weights are changed according to

w′_{i,j}⁽ⁿ⁾=w_{i,j}^{(̅n̅)̅}−γ·δⱼ⁽ⁿ⁾·xᵢ⁽ⁿ⁾

where γ is a learning rate, and the numbers δ⁽ⁿ⁾ⱼ may be recursively calculated as

δⱼ⁽ⁿ⁾=(Σₖδₖ⁽ⁿ⁺¹⁾·w_{j,k}⁽ⁿ⁺¹⁾)·f′(Σᵢxᵢ⁽ⁿ⁾·w_{i,j}⁽ⁿ⁾)

based on δ(n+1)j, if the (n+1)-th layer is not the output layer, and

δⱼ⁽ⁿ⁾=(xₖ⁽ⁿ⁺¹⁾−tⱼ⁽ⁿ⁺¹⁾)·f′(Σᵢxᵢ⁽ⁿ⁾·w_{i,j}⁽ⁿ⁾)

if the (n+1)-th layer is the output layer 2013, where f′ is the first derivative of the activation function, and y⁽ⁿ⁺¹⁾ⱼ is the comparison training value for the j-th node of the output layer 2013.

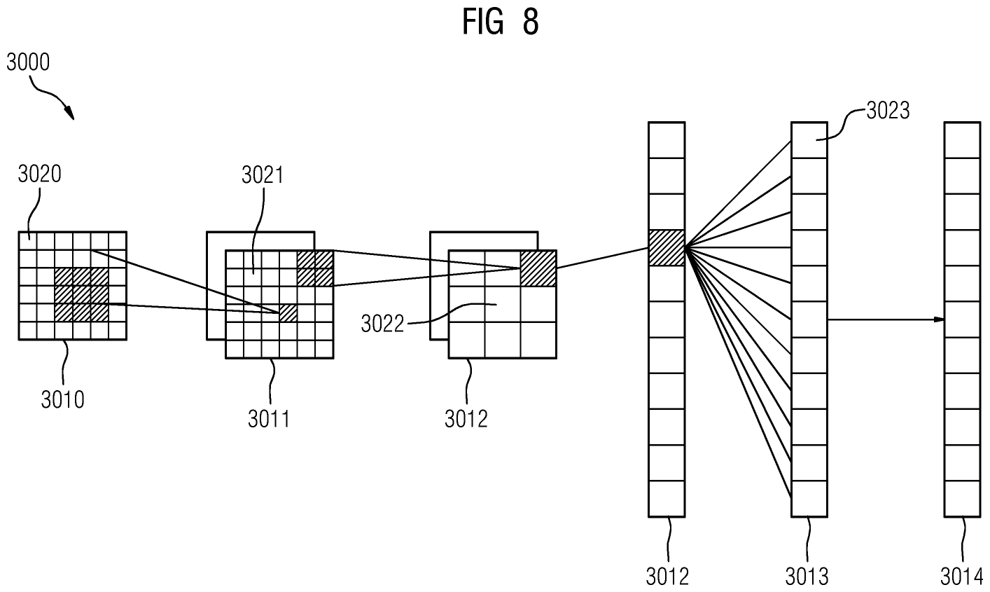

FIG. 8 displays an embodiment of a convolutional neural network 3000 that may be used in the context of providing an alarm relating to anomaly scores assigned to input data, such as detecting a distribution drift of the incoming data using anomaly detection models.

In the displayed embodiment, the convolutional neural network 3000 includes an input layer 3010, a convolutional layer 3011, a pooling layer 3012, a fully connected layer 3013, and an output layer 3014. Alternatively, the convolutional neural network 3000 may include a number of convolutional layers 3011, a number of pooling layers 3012, and a number of fully connected layers 3013, as well as other types of layers. The order of the layers may be chosen arbitrarily, usually fully connected layers 3013 are used as the last layers before the output layer 3014.

For example, within a convolutional neural network 3000, the nodes 3020, . . . , 3024 of one layer 3010, . . . , 3014 may be considered to be arranged as a d-dimensional matrix or as a d-dimensional image. For example, in the two-dimensional case, the value of the node 3020, . . . , 3024 indexed with i and j in the n-th layer 3010, . . . , 3014 may be denoted as x⁽ⁿ⁾_{[i,j]}. However, the arrangement of the nodes 3020, . . . , 3024 of one layer 3010, . . . , 3014 does not have an effect on the calculations executed within the convolutional neural network 3000 as such, since these are given solely by the structure and the weights of the edges.

For example, a convolutional layer 3011 is characterized by the structure and the weights of the incoming edges forming a convolution operation based on a certain number of kernels. For example, the structure and the weights of the incoming edges are chosen such that the values x⁽ⁿ⁾ₖ of the nodes 3021 of the convolutional layer 3011 are calculated as a convolution x⁽ⁿ⁾ₖ=Kₖ*x⁽ⁿ⁻¹⁾ based on the values x⁽ⁿ⁻¹⁾ of the nodes 3020 of the preceding layer 3010, where the convolution * is defined in the two-dimensional case as

xₖ⁽ⁿ⁾[i, j]=(Kₖ*x⁽ⁿ⁻¹⁾)[i, j]=Σᵢ, Σⱼ, Kₖ[i′, j′]·x⁽ⁿ⁻¹⁾[i−i′, j−j′].

The k-th kernel Kk is a d-dimensional matrix (e.g., a two-dimensional matrix), which may be small compared to the number of nodes 3020, . . . , 3024; a 3×3 matrix, or a 5×5 matrix). For example, this implies that the weights of the incoming edges are not independent but chosen such that the weights produce the convolution equation. For example, for a kernel being a 3×3 matrix, there are only 9 independent weights (e.g., each entry of the kernel matrix corresponding to one independent weight), irrespective of the number of nodes 3020, . . . , 3024 in the respective layer 3010, . . . , 3014. For example, for a convolutional layer 3011, the number of nodes 3021 in the convolutional layer is equivalent to the number of nodes 3020 in the preceding layer 3010 multiplied with the number of kernels.

If the nodes 3020 of the preceding layer 3010 are arranged as a d-dimensional matrix, using a plurality of kernels may be interpreted as adding a further dimension (denoted as “depth” dimension), so that the nodes 3021 of the convolutional layer 3021 are arranged as a (d+1)-dimensional matrix. If the nodes 3020 of the preceding layer 3010 are already arranged as a (d+1)-dimensional matrix including a depth dimension, using a plurality of kernels may be interpreted as expanding along the depth dimension, so that the nodes 3021 of the convolutional layer 3021 are arranged also as a (d+1)-dimensional matrix, where the size of the (d+1)-dimensional matrix with respect to the depth dimension is by a factor of the number of kernels larger than in the preceding layer 3010.

The advantage of using convolutional layers 3011 is that spatially local correlation of the input data may exploited by enforcing a local connectivity pattern between nodes of adjacent layers (e.g., by each node being connected to only a small region of the nodes of the preceding layer).

In the displayed embodiment, the input layer 3010 includes 36 nodes 3020, arranged as a two-dimensional 6×6 matrix. The convolutional layer 3011 includes 72 nodes 3021, arranged as two two-dimensional 6×6 matrices, each of the two matrices being the result of a convolution of the values of the input layer with a kernel. Equivalently, the nodes 3021 of the convolutional layer 3011 may be interpreted as arranges as a three-dimensional 6×6×2 matrix, where the last dimension is the depth dimension.

A pooling layer 3012 may be characterized by the structure and the weights of the incoming edges and the activation function of its nodes 3022 forming a pooling operation based on a non-linear pooling function f. For example, in the two-dimensional case, the values x⁽ⁿ⁾ of the nodes 3022 of the pooling layer 3012 may be calculated based on the values x⁽ⁿ⁻¹⁾ of the nodes 3021 of the preceding layer 3011 as

x⁽ⁿ⁾[i, j]=f(x⁽ⁿ⁻¹⁾[id₁, jd₂], . . . , x⁽ⁿ⁻¹⁾[id₁+d₁−1, jd₂+d₂−1])

In other words, by using a pooling layer 3012, the number of nodes 3021, 3022 may be reduced by replacing a number d1·d2 of neighboring nodes 3021 in the preceding layer 3011 with a single node 3022 being calculated as a function of the values of the number of neighboring nodes in the pooling layer. For example, the pooling function f may be the max-function, the average, or the L2-Norm. For example, for a pooling layer 3012, the weights of the incoming edges are fixed and are not modified by training.

The advantage of using a pooling layer 3012 is that the number of nodes 3021, 3022 and the number of parameters is reduced. This leads to the amount of computation in the network being reduced and to a control of overfitting.

In the displayed embodiment, the pooling layer 3012 is a max-pooling, replacing four neighboring nodes with only one node, the value being the maximum of the values of the four neighboring nodes. The max-pooling is applied to each d-dimensional matrix of the previous layer; in this embodiment, the max-pooling is applied to each of the two two-dimensional matrices, reducing the number of nodes from 72 to 18.

A fully connected layer 3013 may be characterized by the fact that a majority of edges (e.g., all edges between nodes 3022 of the previous layer 3012 and the nodes 3023 of the fully connected layer 3013) are present and the weight of each of the edges may be adjusted individually.

In this embodiment, the nodes 3022 of the preceding layer 3012 of the fully connected layer 3013 are displayed both as two-dimensional matrices, and additionally as non-related nodes (e.g., indicated as a line of nodes, where the number of nodes was reduced for a better presentability). In this embodiment, the number of nodes 3023 in the fully connected layer 3013 is equal to the number of nodes 3022 in the preceding layer 3012. Alternatively, the number of nodes 3022, 3023 may differ.

Further, in this embodiment, the values of the nodes 3024 of the output layer 3014 are determined by applying the Softmax function onto the values of the nodes 3023 of the preceding layer 3013. By applying the Softmax function, the sum of the values of all nodes 3024 of the output layer is 1, and all values of all nodes 3024 of the output layer are real numbers between 0 and 1. For example, if using the convolutional neural network 3000 for categorizing input data, the values of the output layer may be interpreted as the probability of the input data falling into one of the different categories.

A convolutional neural network 3000 may also include a ReLU rectified linear units (ReLU) layer. For example, the number of nodes and the structure of the nodes contained in a ReLU layer is equivalent to the number of nodes and the structure of the nodes contained in the preceding layer. For example, the value of each node in the ReLU layer is calculated by applying a rectifying function to the value of the corresponding node of the preceding layer. Examples for rectifying functions are f(x)=max(0,x), the tangent hyperbolics function, or the sigmoid function.

For example, convolutional neural networks 3000 may be trained based on the backpropagation algorithm. For preventing overfitting, methods of regularization may be used (e.g., dropout of nodes 3020, . . . , 3024, stochastic pooling, use of artificial data, weight decay based on the L1 or the L2 norm, or max norm constraints).

While the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, a thread of execution, and/or the like. Still further, results of acts of the methodologies may be stored in a computer-readable medium, displayed on a display device, and/or the like.

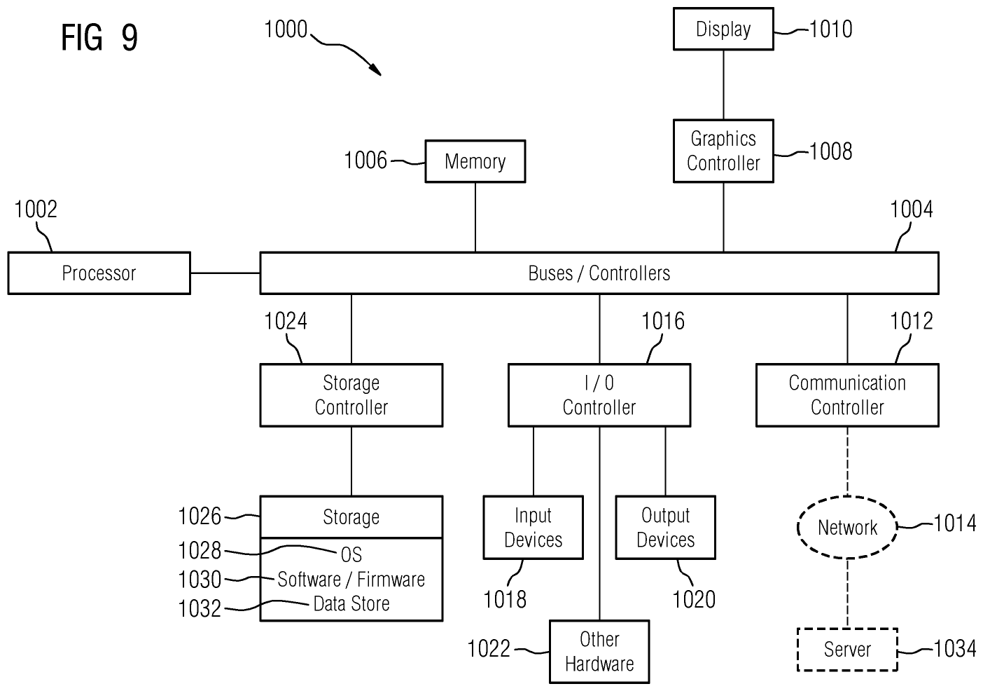

FIG. 9 illustrates a block diagram of a data processing system 1000 (e.g., a computer system) in which an embodiment may be implemented, for example, as a portion of a product system, and/or other system operatively configured by software or otherwise to perform the processes as described herein. The data processing system 1000 may include, for example, the computer or IT system or data processing system 100 mentioned above. The data processing system depicted includes at least one processor 1002 (e.g., a CPU) that may be connected to one or more bridges/controllers/buses 1004 (e.g., a north bridge, a south bridge). One of the buses 1004, for example, may include one or more I/O buses such as a PCI Express bus. Also connected to various buses in the depicted example may include a main memory 1006 (RAM) and a graphics controller 1008. The graphics controller 1008 may be connected to one or more display devices 1010. In some embodiments, one or more controllers (e.g., graphics, south bridge) may be integrated with the CPU (e.g., on the same chip or die). Examples of CPU architectures include IA-32, x86-64, and ARM processor architectures.

Other peripherals connected to one or more buses may include communication controllers 1012 (e.g., Ethernet controllers, WiFi controllers, cellular controllers) operative to connect to a local area network (LAN), Wide Area Network (WAN), a cellular network, and/or other wired or wireless networks 1014 or communication equipment.

Further components connected to various busses may include one or more I/O controllers 1016 such as USB controllers, Bluetooth controllers, and/or dedicated audio controllers (e.g., connected to speakers and/or microphones). Various peripherals may be connected to the I/O controller(s) (e.g., via various ports and connections) including input devices 1018 (e.g., keyboard, mouse, pointer, touch screen, touch pad, drawing tablet, trackball, buttons, keypad, game controller, gamepad, camera, microphone, scanners, motion sensing devices that capture motion gestures), output devices 1020 (e.g., printers, speakers) or any other type of device that is operative to provide inputs to or receive outputs from the data processing system. Also, many devices referred to as input devices or output devices may both provide inputs and receive outputs of communications with the data processing system. For example, the processor 1002 may be integrated into a housing (e.g., a tablet) that includes a touch screen that serves as both an input and display device. Further, some input devices (e.g., a laptop) may include a plurality of different types of input devices (e.g., touch screen, touch pad, keyboard). Also, other peripheral hardware 1022 connected to the I/O controllers 1016 may include any type of device, machine, or component that is configured to communicate with a data processing system.

Additional components connected to various busses may include one or more storage controllers 1024 (e.g., SATA). A storage controller may be connected to a storage device 1026 such as one or more storage drives and/or any associated removable media that may be any suitable non-transitory machine usable or machine-readable storage medium. Examples include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and/or computer media. Also, in some examples, a storage device such as an SSD may be connected directly to an I/O bus 1004 such as a PCI Express bus.

A data processing system in accordance with an embodiment of the present disclosure may include an operating system 1028, software/firmware 1030, and data stores 1032 (e.g., that may be stored on a storage device 1026 and/or the memory 1006). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 1012 may be connected to the network 1014 (not a part of data processing system 1000), which may be any public or private data processing system network or combination of networks, as known to those of skill in the art, including the Internet. Data processing system 1000 may communicate over the network 1014 with one or more other data processing systems such as a server 1034 (also not part of the data processing system 1000). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across a number of data processing systems organized in a distributed system in communication with each other via a network.

Further, the term “controller” may be any device, system, or part thereof that controls at least one operation, whether such a device is implemented in hardware, firmware, software, or some combination of at least two of the same. The functionality associated with any particular controller may be centralized or distributed, whether locally or remotely.

In addition, data processing systems may be implemented as virtual machines in a virtual machine architecture or cloud environment. For example, the processor 1002 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 1000 in this example may correspond to a computer, workstation, server, PC, notebook computer, tablet, mobile phone, and/or any other type of apparatus/system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

Also, the processor described herein may be located in a server that is remote from the display and input devices described herein. In such an example, the described display device and input device may be comprised in a client device that communicates with the server (and/or a virtual machine executing on the server) through a wired or wireless network (which may comprise the Internet). In some embodiments, such a client device, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In such examples, the processor described herein may correspond to a virtual processor of a virtual machine executing in a physical processor of the server.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein, a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 1000 may conform to any of the various current implementations and practices known in the art.

Also, the words or phrases used herein should be construed broadly, unless expressly limited in some examples. For example, the terms “comprise” and “comprise,” as well as derivatives thereof, may provide inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, providing and/or, unless the context clearly indicates otherwise. The phrases “associated with” and “associated therewith,” as well as derivatives thereof, may be to comprise, be comprised within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to describe various elements, functions, or acts, these elements, functions, or acts should not be limited by these terms. Rather, these numeral adjectives are used to distinguish different elements, functions, or acts from each other. For example, a first element, function, or act may be termed a second element, function, or act, and, similarly, a second element, function, or act may be termed a first element, function, or act, without departing from the scope of the present disclosure.

In addition, phrases such as “processor is configured to” carry out one or more functions or processes, may be that the processor is operatively configured to or operably configured to carry out the functions or processes via software, firmware, and/or wired circuits. For example, a processor that is configured to carry out a function/process may correspond to a processor that is executing the software/firmware, which is programmed to cause the processor to carry out the function/process and/or may correspond to a processor that has the software/firmware in a memory or storage device that is available to be executed by the processor to carry out the function/process. A processor that is “configured to” carry out one or more functions or processes may also correspond to a processor circuit particularly fabricated or “wired” to carry out the functions or processes (e.g., an ASIC or FPGA design). Further the phrase “at least one” before an element (e.g., a processor) that is configured to carry out more than one function may correspond to one or more elements (e.g., processors) that each carry out the functions and may also correspond to two or more of the elements (e.g., processors) that respectively carry out different ones of the one or more different functions.

In addition, the term “adjacent to” may provide that an element is relatively near to but not in contact with a further element, or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present patent document should be read as implying that any particular element, step, act, or function is an essential element, which must be comprised in the claim scope: the scope of patented subject matter is defined only by the allowed claims.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method comprising:
receiving input data relating to at least one device, wherein the input data comprise comprises incoming data batches relating to at least N separable classes, with nϵ1, . . . , N;
determining respective anomaly scores for the respective incoming data batch relating to the at least N separable classes using N anomaly detection models;
generating output data, the generating of the output data comprising applying the N anomaly detection models to the input data, the output data being suitable for analyzing, monitoring, operating, controlling, or any combination thereof of the respective device;
determining, for the respective incoming data batch, a difference between the determined respective anomaly scores for the at least N separable classes and given respective anomaly scores of the N anomaly detection models; and
when the respective determined difference between is greater than a difference threshold, providing an alarm relating to the determined difference to a user, the respective device, an IT system connected to the respective device, or any combination thereof.

2. The computer-implemented method according to of claim 1, wherein the input data undergoes a distribution drift involving an increase of the determined difference.

3. The computer-implemented method of claim 1, further comprising:
determining a distribution drift of the input data a difference between the anomaly scores of an earlier incoming data batch and the anomaly scores of a later incoming data batch is greater than a second threshold; and
providing a report relating to the determined distribution drift to a user, the respective device, an IT system connected to the respective device, or any combination thereof when if the determined difference is greater than a threshold.

4. The computer-implemented method of claim 1, further comprising:
assigning training data batches to the at least N separable classes of the anomaly detection models; and
determining the given anomaly scores of the at least N separable classes for the N anomaly detection models.

5. The computer-implemented method of claim 1, wherein N=1.

6. The computer-implemented method of claim 1, further comprising:
when the determined difference is smaller than the difference threshold:
embedding the N anomaly detection models in a software application for analyzing, monitoring, operating, controlling, or any combination thereof of the at least one device; and
deploying the software application on the at least one device or an IT system connected to the at least one device, such that the software application is usable for analyzing, monitoring, operating, controlling, or any combination thereof of the at least one device.

7. The computer-implemented method of claim 6, further comprising, when the determined difference is greater than the difference threshold:
amending the respective anomaly detection models, such that a determined difference using the respective amended anomaly detection models is smaller than the difference threshold;
replacing the respective anomaly detection models with the respective amended anomaly detection models in the software application; and
deploying the amended software application on the at least one device or the IT system.

8. The computer-implemented method of claim 6, further comprising, when the amendment of the anomaly detection models takes more time than a duration threshold:
replacing the deployed software application with a backup software application; and
analyzing, monitoring, operating, controlling, or any combination thereof of the at least one device using the backup software application.

9. The computer-implemented method of claim 1, further comprising, for a plurality of interconnected devices:
embedding respective N detection models in a respective software application for analyzing, monitoring, operating, controlling, or any combination thereof of the respective interconnected devices;
deploying the respective software application on the respective interconnected devices or an IT system connected to the plurality of interconnected devices, such that the respective software application is usable for analyzing, monitoring, operating, controlling, or any combination thereof of the respective interconnected devices;
determining a respective difference of the respective anomaly detection models; and
the respective, determined difference is greater than a respective difference threshold:
providing an alarm relating to the determined difference and the respective interconnected devices for which the corresponding respective software application used for analyzing, monitoring, operating, controlling, or any combination thereof of the respective interconnected device(s) devices to a user, the respective device, an automation system, or any combination thereof.

10. The computer-implemented method of claim 1, wherein the respective device is a production machine, an automation device, a sensor, a production monitoring device, a vehicle or any combination thereof.

11. A system comprising:
a first interface configured to receive input data relating to at least one device, wherein the input data comprises incoming data batches relating to at least N separable classes, with nϵ1, . . . , N;
a computation unit configured to:
determine respective anomaly scores for the respective incoming data batch relating to the at least N separable classes using N anomaly detection models;
generate output data the generation of the output data comprising application of the anomaly detection models to the input data, the output data being suitable for analyzing, monitoring, operating, controlling, or any combination thereof of the respective device; and
determine, for the respective incoming data batch, a difference between the determined respective anomaly scores for the at least N separable classes and given respective anomaly scores of the N anomaly detection models; and
a second interface, configured to provide an alarm relating to the determined difference to a user, the respective device, an IT system connected to the respective device, or a combination thereof when the respective determined difference between is greater than a difference threshold.

12. (canceled)

13. In a non-transitory computer-readable storage medium that stores instructions executable by a system, the instructions comprising:
receiving input data relating to at least one device, wherein the input data comprises incoming data batches relating to at least N separable classes, with nϵ1, . . . , N;
determining respective anomaly scores for the respective incoming data batch relating to the at least N separable classes using N anomaly detection models; and
generating output data, the generating of the output data comprising applying the N anomaly detection models to the input data, the output data being suitable for analyzing, monitoring, operating, controlling, or any combination thereof of the respective device;
determining, for the respective incoming data batch, a difference between the determined respective anomaly scores for the at least N separable classes and given respective anomaly scores of the N anomaly detection models; and
when the respective determined difference between is greater than a difference threshold, providing an alarm relating to the determined difference to a user, the respective device, an IT system connected to the respective device, or any combination thereof.

14. The non-transitory computer-readable storage medium of claim 13, wherein the input data undergoes a distribution drift involving an increase of the determined difference.

15. The non-transitory computer-readable storage medium of claim 13, wherein the instructions further comprise:
determining a distribution drift of the input data difference between the anomaly scores of an earlier incoming data batch and the anomaly scores of a later incoming data batch is greater than a second threshold; and
providing a report relating to the determined distribution drift to a user, the respective device, an IT system connected to the respective device, or any combination thereof when the determined difference is greater than a threshold.

16. The non-transitory computer-readable storage medium of claim 13, wherein the instructions further comprise:
assigning training data batches to the at least N separable classes of the anomaly detection models; and
determining the given anomaly scores of the at least N separable classes for the N anomaly detection models.

17. The non-transitory computer-readable storage medium of claim 13, wherein N=1.

18. The non-transitory computer-readable storage medium of claim 13, wherein the instructions further comprise:
determining, for the respective incoming data batch, a difference between the determined respective anomaly scores for the at least N separable classes and given respective anomaly scores of the N anomaly detection models; and
when the respective determined difference between is greater than a difference threshold, providing an alarm relating to the determined difference to a user, the respective device, an IT system connected to the respective device, or any combination thereof.

19. The system of claim 11, wherein the system is an IT system.
